(19) United States
(12) Patent Application Publication
(10) Pub. No.: US 2017/0155967 A1
(43) Pub. Date: Jun. 1, 2017

(54) METHOD AND APPARATUS FOR FACILITAING LIVE VIRTUAL REALITY STREAMING

(71) Applicant: Nokia Technologies Oy, Espoo (FI)

(72) Inventors: Hoseok Chang, Sunnyvale, CA (US); Hui Zhou, Sunnyvale, CA (US); Basavaraja Vandrotti, Sunnyvale, CA (US); Prasad Balasubramanian, Sunnyvale, CA (US); Per-Ola Robertsson, Sunnyvale, CA (US); Maneli Noorkami, Sunnyvale, CA (US)

(21) Appl. No.: 15/365,062

(22) Filed: Nov. 30, 2016

Related U.S. Application Data
(60) Provisional application No. 62/261,001, filed on Nov. 30, 2015.

(51) Int. Cl. H04N 21/61; H04N 21/84; H04N 21/439; H04N 21/238; H04N 21/44; H04N 21/6587; H04N 21/2187; H04N 21/81

(52) U.S. Cl. CPC H04N 21/6125; H04N 21/2187; H04N 21/84; H04N 21/816; H04N 21/238; H04N 21/44008; H04N 21/6587; H04N 21/4394

(57) ABSTRACT

Various methods are provided for facilitating live virtual reality streaming, and more specifically, for facilitating dynamic metadata transmission, stream tiling, and attention based active view processing, encoding, and rendering. One example method may receiving an indication of a position of a display unit, determining, based on the indication of the position of the display unit, at least one active view associated with the position of the display, the at least one active view being a first view of a plurality of views, and causing transmission of first video content corresponding to the at least one active view, the first video content configured for display on the display unit.

### CROSS-REFERENCE TO RELATED APPLICATION

This application claims priority from and the benefit of the filing date of U.S. Provisional Patent Application No. 62/261,001 filed Nov. 30, 2015 the contents of which are incorporated by reference in its entirety herein.

### TECHNOLOGICAL FIELD

Embodiments of the present invention relate generally to a method, apparatus, and computer program product for facilitating live virtual reality (VR) streaming, and more specifically, for facilitating dynamic metadata transmission, stream tiling, and attention based active view processing, encoding, and rendering.

### BACKGROUND

The increased use and capabilities of mobile devices coupled with decreased costs of storage have caused an increase in streaming services. However, because the transmission of data is bandwidth limited, live streaming is not common. That limited capacity (e.g., bandwidth-limited channels) prevents live transmission of many types of content, notably virtual reality (VR) content, which given its need to provide any of many views at a moment's notice is especially bandwidth intensive. However, absent the capability of providing those views, the user cannot truly experience live virtual reality.

The existing approaches for creating VR content are not conducive to live streaming. As such, virtual reality (e.g., creation, transmission, and rendering of VR content) streaming may be less robust than desired for some applications.

### BRIEF SUMMARY

A method, apparatus and computer program product are therefore provided according to an example embodiment of the present invention for facilitating live virtual reality (VR) streaming, and more specifically, for facilitating dynamic metadata transmission, stream tiling, and attention based active view processing, encoding, and rendering.

An apparatus may be provided comprising at least one processor and at least one memory including computer program code, the at least one memory and the computer program code configured to, with the processor, cause the apparatus to cause capture of a plurality of channel streams of video content, cause capture of calibration metadata, wherein each of the plurality of channel streams of video content having associated calibration metadata, generate tiling metadata for use in tiling of the plurality of the channel streams, the tiling metadata indicative of a relative position, within a frame, of each of the plurality of channel streams, tile the plurality of channel streams into a single stream of the video content utilizing the calibration metadata, and cause transmission of the single stream of the video content.

In some embodiments, the at least one memory and the computer program code are further configured to, with the processor, cause the apparatus to partition the calibration metadata and the tiling metadata. In some embodiments, the at least one memory and the computer program code are further configured to, with the processor, cause the apparatus to cause transmission of the tiling metadata within the single stream of the video content. In some embodiments, the tiling metadata is embedded in non-picture regions of the frame.

In some embodiments, the at least one memory and the computer program code are further configured to, with the processor, cause the apparatus to encode the tiled single stream and the tiling metadata, the encoded data configured for display upon reception of the encoded data at a display unit, extraction of the tiling metadata from the encoded data, and mapping of the tiled single stream of the video content to a plurality of different separate channels in accordance with the tiling metadata.

In some embodiments, the tiling of the plurality of channels into the single stream comprises at least one of grid tiling, interleaved tiling, or stretch tiling.

In some embodiments, the camera metadata further comprises audio metadata, wherein the at least one memory and the computer program code are further configured to, with the processor, cause the apparatus to partition the audio metadata from the camera metadata, and cause transmission of the audio metadata within the single stream of the video content.

In some embodiments, the at least one memory and the computer program code are further configured to, with the processor, cause the apparatus to cause transmission of an audio configuration file, the audio configure file configured to output audio data associated with the video content.

In some embodiments, the calibration data comprises at least yaw, pitch, and roll information and filed of view information for each of a plurality of cameras configured to capture of the plurality of channel streams of video content.

In some embodiments, an apparatus may be provided comprising at least one processor and at least one memory including computer program code, the at least one memory and the computer program code configured to, with the processor, cause the apparatus to at least receive an indication of a position of a display unit, determine, based on the indication of the position of the display unit, at least one active view associated with the position of the display, the at least one active view being a first view of a plurality of views, and cause transmission of first video content corresponding to the at least one active view, the first video content configured for display on the display unit.

In some embodiments, the at least one memory and the computer program code are further configured to, with the processor, cause the apparatus to identify one or more second views from the plurality of views, the second views being potential next active views, and cause transmission of second video content corresponding to at least one of the one or more second views, the second video content configured for display on the display unit upon a determination that the position of the display unit has changed, wherein the computer program code for identifying one of the one or more second view are further comprises computer program code configured to, with the processor, cause the apparatus to identify one or more adjacent views, each of the one or more adjacent view being adjacent to the at least one active view, determine an attention level of each of the one or more adjacent views, rank the attention level of each of the one or more adjacent views, and determine that the potential active view is the adjacent view with the highest attention level.

In some embodiments, the at least one memory and the computer program code are further configured to, with the processor, cause the apparatus to upon capture of video content, associate at least camera calibration metadata and audio metadata with the video content.

In some embodiments, the at least one memory and the computer program code are further configured to, with the processor, cause the apparatus to cause partitioning the camera calibration metadata, the audio metadata, and the tiling metadata.

In some embodiments, the at least one memory and the computer program code are further configured to, with the processor, cause the apparatus to cause transmission of the tiling metadata associated with the video content.

In some embodiments, the at least one memory and the computer program code are further configured to, with the processor, cause the apparatus to cause transmission of an audio configuration file, the audio configure file configured to output audio data associated with the video content.

In some embodiments, the at least one memory and the computer program code are further configured to, with the processor, cause the apparatus to cause capture of a plurality of channel streams of video content, and tile the plurality of channel streams into a single stream.

In some embodiments, the tiling of the plurality of channels into the single stream comprises at least one of grid tiling, interleaved tiling, or stretch tiling. In some embodiments, the display unit is a head mounted display unit.

In some embodiments, a computer program product may be provided comprising at least one non-transitory computer-readable storage medium having computer-executable program code instructions stored therein, the computer-executable program code instructions comprising program code instructions for causing capture of a plurality of channel streams of video content, causing capture of calibration metadata, wherein each of the plurality of channel streams of video content having associated calibration metadata, generating tiling metadata for use in tiling of the plurality of the channel streams, the tiling metadata indicative of a relative position, within a frame, of each of the plurality of channel streams, tiling the plurality of channel streams into a single stream of the video content utilizing the calibration metadata, and causing transmission of the single stream of the video content

In some embodiments, the computer-executable program code instructions further comprise program code instructions for partitioning the calibration metadata and the tiling metadata. In some embodiments, the computer-executable program code instructions further comprise program code instructions for causing transmission of the tiling metadata within the single stream of the video content. In some embodiments, the tiling metadata is embedded in non-picture regions of the frame.

In some embodiments, the computer-executable program code instructions further comprise program code instructions for encoding the tiled single stream and the tiling metadata, the encoded data configured for display upon reception of the encoded data at a display unit, extraction of the tiling metadata from the encoded data, and mapping of the tiled single stream of the video content to a plurality of different separate channels in accordance with the tiling metadata.

In some embodiments, the tiling of the plurality of channels into the single stream comprises at least one of grid tiling, interleaved tiling, or stretch tiling.

In some embodiments, the camera metadata further comprises audio metadata, and wherein the computer-executable program code instructions further comprise program code instructions for partitioning the audio metadata from the camera metadata, and cause transmission of the audio metadata within the single stream of the video content.

In some embodiments, the computer-executable program code instructions further comprise program code instructions for causing transmission of an audio configuration file, the audio configure file configured to output audio data associated with the video content.

In some embodiments, the calibration data comprises at least yaw, pitch, and roll information and filed of view information for each of a plurality of cameras configured to capture of the plurality of channel streams of video content.

In some embodiments, a computer program product may be provided comprising at least one non-transitory computer-readable storage medium having computer-executable program code instructions stored therein, the computer-executable program code instructions comprising program code instructions for receiving an indication of a position of a display unit, determining, based on the indication of the position of the display unit, at least one active view associated with the position of the display, the at least one active view being a first view of a plurality of views, and causing transmission of first video content corresponding to the at least one active view, the first video content configured for display on the display unit.

In some embodiments, the computer-executable program code instructions further comprise program code instructions for identifying one or more second views from the plurality of views, the second views being potential next active views, and causing transmission of second video content corresponding to at least one of the one or more second views, the second video content configured for display on the display unit upon a determination that the position of the display unit has changed, wherein the computer-executable program code instructions for identifying one of the one or more second view are further comprises program code instructions for identifying one or more adjacent views, each of the one or more adjacent view being adjacent to the at least one active view, determining an attention level of each of the one or more adjacent views, ranking the attention level of each of the one or more adjacent views, and determining that the potential active view is the adjacent view with the highest attention level.

In some embodiments, the computer-executable program code instructions further comprise program code instructions for, upon capture of video content, associating at least camera calibration metadata and audio metadata with the video content.

In some embodiments, the computer-executable program code instructions further comprise program code instructions for partitioning the camera calibration metadata, the audio metadata, and the tiling metadata. In some embodiments, the computer-executable program code instructions further comprise program code instructions for causing transmission of the tiling metadata associated with the video content. In some embodiments, the computer-executable program code instructions further comprise program code instructions for causing transmission of an audio configuration file, the audio configure file configured to output audio data associated with the video content.

In some embodiments, the computer-executable program code instructions further comprise program code instructions for causing capture of a plurality of channel streams of video content, and tiling the plurality of channel streams into a single stream. In some embodiments, the tiling of the plurality of channels into the single stream comprises at least one of grid tiling, interleaved tiling, or stretch tiling. In some embodiments, the display unit is a head mounted display unit.

In some embodiments, a method may be provided comprising causing capture of a plurality of channel streams of video content, causing capture of calibration metadata, wherein each of the plurality of channel streams of video content having associated calibration metadata, generating tiling metadata for use in tiling of the plurality of the channel streams, the tiling metadata indicative of a relative position, within a frame, of each of the plurality of channel streams, tiling the plurality of channel streams into a single stream of the video content utilizing the calibration metadata, and causing transmission of the single stream of the video content.

In some embodiments, the method may further comprise partitioning the calibration metadata and the tiling metadata. In some embodiments, the method may further comprise causing transmission of the tiling metadata within the single stream of the video content. In some embodiments, the tiling metadata is embedded in non-picture regions of the frame.

In some embodiments, the method may further comprise encoding the tiled single stream and the tiling metadata, the encoded data configured for display upon reception of the encoded data at a display unit, extraction of the tiling metadata from the encoded data, and mapping of the tiled single stream of the video content to a plurality of different separate channels in accordance with the tiling metadata.

In some embodiments, the tiling of the plurality of channels into the single stream comprises at least one of grid tiling, interleaved tiling, or stretch tiling.

In some embodiments, the camera metadata further comprises audio metadata, and wherein the method may further comprise partitioning the audio metadata from the camera metadata, and causing transmission of the audio metadata within the single stream of the video content. In some embodiments, the method may further comprise causing transmission of an audio configuration file, the audio configure file configured to output audio data associated with the video content. In some embodiments, the calibration data comprises at least yaw, pitch, and roll information and filed of view information for each of a plurality of cameras configured to capture of the plurality of channel streams of video content.

In some embodiments, a method may be provided comprising receiving an indication of a position of a display unit, determining, based on the indication of the position of the display unit, at least one active view associated with the position of the display, the at least one active view being a first view of a plurality of views, and causing transmission of first video content corresponding to the at least one active view, the first video content configured for display on the display unit.

In some embodiments, the method may further comprise identifying one or more second views from the plurality of views, the second views being potential next active views, and causing transmission of second video content corresponding to at least one of the one or more second views, the second video content configured for display on the display unit upon a determination that the position of the display unit has changed, wherein the identifying one of the one or more second view further comprises identifying one or more adjacent views, each of the one or more adjacent view being adjacent to the at least one active view, determining an attention level of each of the one or more adjacent views, ranking the attention level of each of the one or more adjacent views, and determining that the potential active view is the adjacent view with the highest attention level.

In some embodiments, the method may further comprise, upon capture of video content, associating at least camera calibration metadata and audio metadata with the video content. In some embodiments, the method may further comprise partitioning the camera calibration metadata, the audio metadata, and the tiling metadata. In some embodiments, the method may further comprise causing transmission of the tiling metadata associated with the video content.

In some embodiments, the method may further comprise causing transmission of an audio configuration file, the audio configure file configured to output audio data associated with the video content. In some embodiments, the method may further comprise causing capture of a plurality of channel streams of video content, and tiling the plurality of channel streams into a single stream. In some embodiments, the tiling of the plurality of channels into the single stream comprises at least one of grid tiling, interleaved tiling, or stretch tiling. In some embodiments, the display unit is a head mounted display unit.

In some embodiments, an apparatus may be provided comprising means for causing capture of a plurality of channel streams of video content, means for causing capture of calibration metadata, wherein each of the plurality of channel streams of video content having associated calibration metadata, means for generating tiling metadata for use in tiling of the plurality of the channel streams, the tiling metadata indicative of a relative position, within a frame, of each of the plurality of channel streams, means for tiling the plurality of channel streams into a single stream of the video content utilizing the calibration metadata, and means for causing transmission of the single stream of the video content

In some embodiments, the apparatus may further comprise means for partitioning the calibration metadata and the tiling metadata. In some embodiments, the apparatus may further comprise means for causing transmission of the tiling metadata within the single stream of the video content. In some embodiments, the tiling metadata is embedded in non-picture regions of the frame.

In some embodiments, the apparatus may further comprise means for encoding the tiled single stream and the tiling metadata, the encoded data configured for display upon reception of the encoded data at a display unit, extraction of the tiling metadata from the encoded data, and mapping of the tiled single stream of the video content to a plurality of different separate channels in accordance with the tiling metadata. In some embodiments, the tiling of the plurality of channels into the single stream comprises at least one of grid tiling, interleaved tiling, or stretch tiling.

In some embodiments, the camera metadata further comprises audio metadata, and wherein the apparatus may further comprise means for partitioning the audio metadata from the camera metadata, and means for causing transmission of the audio metadata within the single stream of the video content.

In some embodiments, the apparatus may further comprise means for causing transmission of an audio configuration file, the audio configure file configured to output audio data associated with the video content.

In some embodiments, the calibration data comprises at least yaw, pitch, and roll information and filed of view information for each of a plurality of cameras configured to capture of the plurality of channel streams of video content.

In some embodiments, an apparatus may be provided comprising means for receiving an indication of a position of a display unit, means for determining, based on the indication of the position of the display unit, at least one active view associated with the position of the display, the at least one active view being a first view of a plurality of views, and means for causing transmission of first video content corresponding to the at least one active view, the first video content configured for display on the display unit.

In some embodiments, the apparatus may further comprise means for identifying one or more second views from the plurality of views, the second views being potential next active views, and means for causing transmission of second video content corresponding to at least one of the one or more second views, the second video content configured for display on the display unit upon a determination that the position of the display unit has changed, wherein the means for identifying one of the one or more second view are further comprises means for identifying one or more adjacent views, each of the one or more adjacent view being adjacent to the at least one active view, means for determining an attention level of each of the one or more adjacent views, means for ranking the attention level of each of the one or more adjacent views, and means for determining that the potential active view is the adjacent view with the highest attention level.

In some embodiments, the apparatus may further comprise, upon capture of video content, means for associating at least camera calibration metadata and audio metadata with the video content. In some embodiments, the apparatus may further comprise means for partitioning the camera calibration metadata, the audio metadata, and the tiling metadata.

In some embodiments, the apparatus may further comprise means for causing transmission of the tiling metadata associated with the video content.

In some embodiments, the apparatus may further comprise means for causing transmission of an audio configuration file, the audio configure file configured to output audio data associated with the video content.

In some embodiments, the apparatus may further comprise means for causing capture of a plurality of channel streams of video content, and means for tiling the plurality of channel streams into a single stream. In some embodiments, the tiling of the plurality of channels into the single stream comprises at least one of grid tiling, interleaved tiling, or stretch tiling.

In some embodiments, the display unit is a head mounted display unit.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is block diagram of a system that may be specifically configured in accordance with an example embodiment of the present invention;

FIG. 3 is a block diagram of an apparatus that may be specifically configured in accordance with an example embodiment of the present invention;

FIG. 4 is a block diagram of an apparatus that may be specifically configured in accordance with an example embodiment of the present invention;

FIG. 5 is a block diagram of an apparatus that may be specifically configured in accordance with an example embodiment of the present invention;

FIG. 6 is a block diagram of an apparatus that may be specifically configured in accordance with an example embodiment of the present invention;

FIGS. 7A, 7B, and 7C show exemplary data flow operations in accordance with an example embodiments of the present invention;

FIGS. 8A, 8B, and 8C show exemplary representations in accordance with an example embodiments of the present invention;

FIGS. 9 and 10 are example flowcharts illustrating methods of operating an example apparatus in accordance with embodiments of the present invention; and

FIG. 11 is block diagram of a system that may be specifically configured in accordance with an example embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

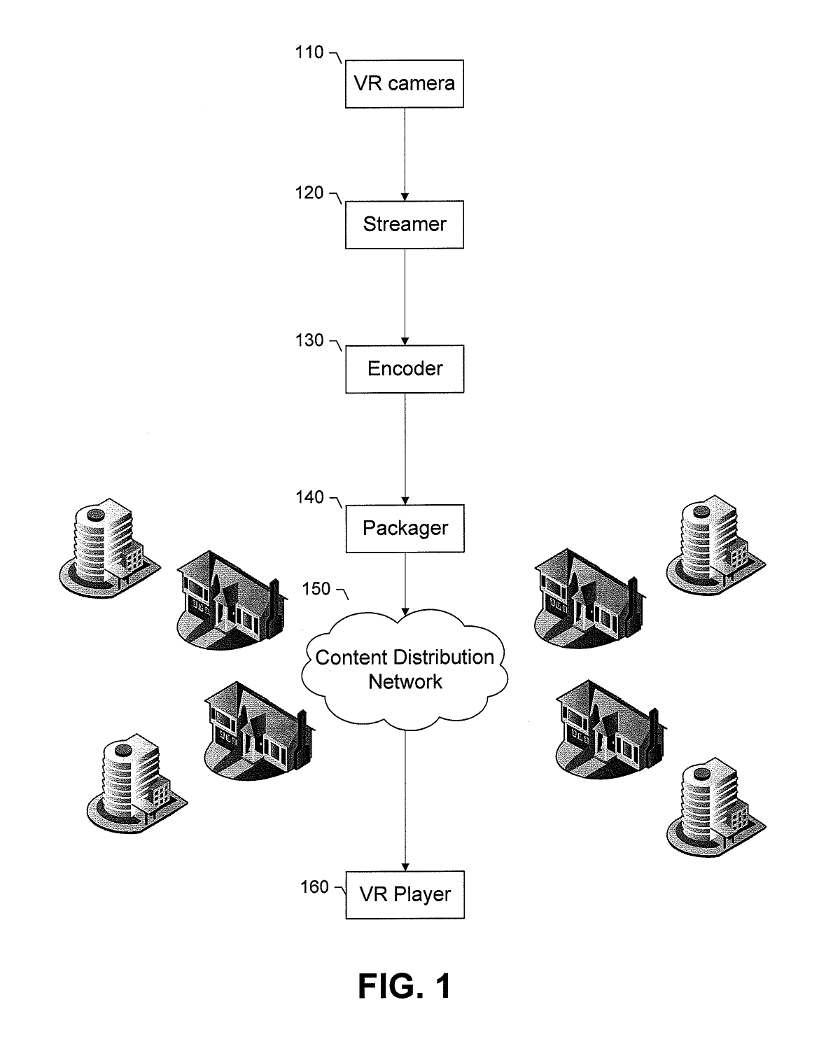

Referring now to FIG. 1, a streaming system is shown that supports, for example, live virtual reality (VR) streaming. In some embodiments, the streaming system enables users to experience virtual reality, for example, in real-time or near real-time (e.g., live or near live) in streaming mode. The streaming system comprises a virtual reality camera (VR camera) 110, streamer 120, encoder 130, packager 140, content distribution network (CDN) 150, and virtual reality player (VR player) 160. VR camera 110 may be configured to capture video content and provide the video content to streamer 120. The streamer 120 may then be configured to receive VR video content in raw format from VR camera 110 and process it in, for example, real time. The streamer 120 may then be configured to transmit the processed video content for encoding and packaging. Encoding and packaging may be performed by encoder 130 and packager 140, respectively. The packaged content may then be distributed through CDN 150 for broadcasting. VR player 160 may be configured to play the broadcasted content allowing a user to watch live VR content using, for example, a head mounted display (HMD) equipment with the VR player 160 installed.

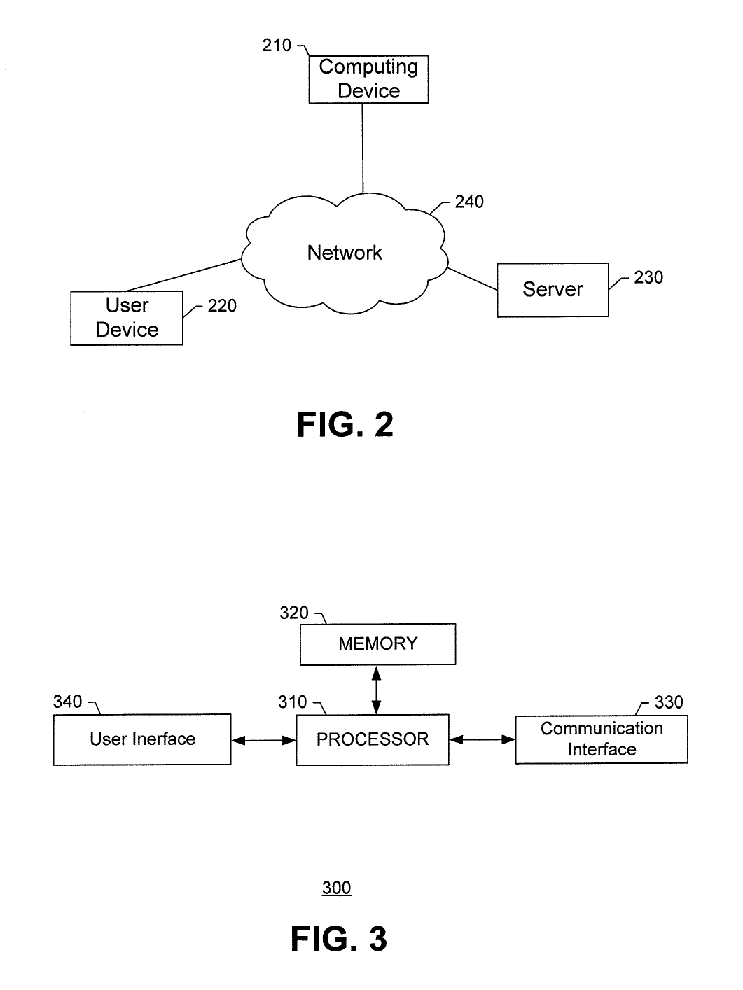

Referring now of FIG. 2, a system that supports communication (e.g., transmission of VR content), either wirelessly or via a wireline, between a computing device 210, user device 220, and a server 230 or other network entity (hereinafter generically referenced as a “server”) is illustrated. As shown, the computing device 210, the user device 220, and the server 230 may be in communication via a network 240, such as a wide area network, such as a cellular network or the Internet, or a local area network. However, the computing device 210, the user device 220, and the server 230 may be in communication in other manners, such as via direct communications. The user device 220 will be hereinafter described as a mobile terminal, mobile device or the like, but may be either mobile or fixed in the various embodiments.

The computing device 210 and user device 220 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device 210 may be a fixed computing device, such as a personal computer, a computer workstation or the like. The server 230 may also be embodied by a computing device and, in one embodiment, is embodied by a web server. Additionally, while the system of FIG. 2 depicts a single server, the server may be comprised of a plurality of servers which may collaborate to support browsing activity conducted by the computing device 210.

Regardless of the type of device that embodies the computing device 210 and/or user device 220, the computing device and/or user device 220 may include or be associated with an apparatus 300 as shown in FIG. 3. In this regard, the apparatus may include or otherwise be in communication with a processor 310, a memory device 320, a communication interface 330 and a user interface 340. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 310 (and/or co-processors or any other processing circuitry assisting or otherwise associated with the processor) may be in communication with the memory device 320 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 300 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 300 may be embodied by a computing device 210 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 310 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 310 may be configured to execute instructions stored in the memory device 320 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 340.

Meanwhile, the communication interface 330 may be any means such as a device or circuitry embodied in either hardware or a combination of hardware and software that is configured to receive and/or transmit data between the computing device 210, user device 220, and server 230. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 340 may be in communication with the processor 310, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), head mounted display (HMD), in the air, etc. The user interface may also be in communication with the memory 320 and/or the communication interface 330, such as via a bus.

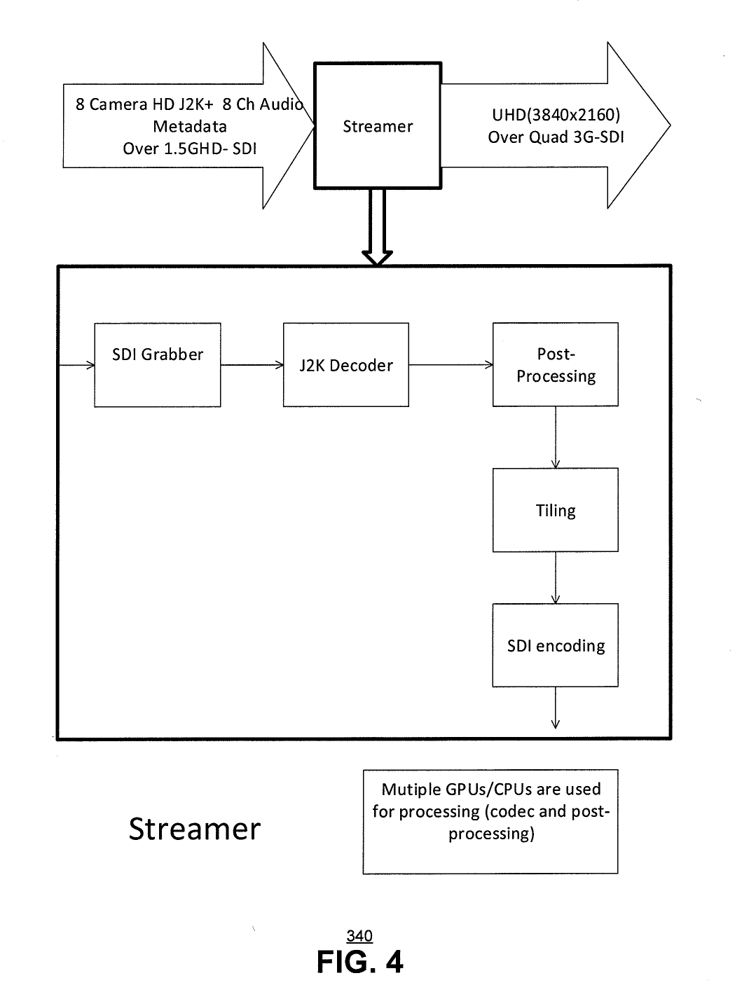

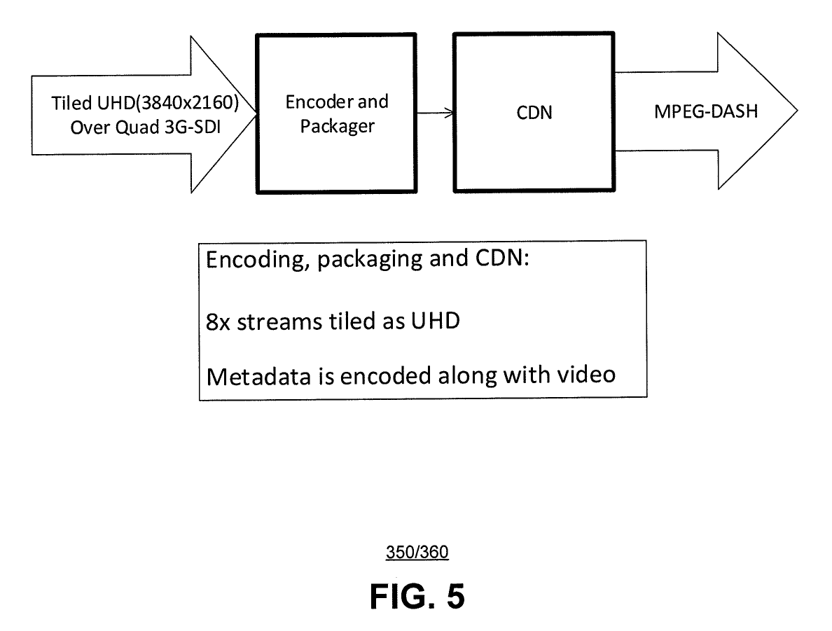

Computing device 210, embodied by apparatus 300, may further be configured to comprise one or more of a streamer module 340, encoder module 350, and packaging module 360. The streamer module 340 is further described with reference to FIG. 4, the encoder module with reference to FIG. 5, and the packaging module with reference to 350. Referring now to FIG. 4, the streamer module 340 may comprise one or more of an SDI grabber 410, a J2k decoder 420, post-processing module 430, tiling module 440, and SDI encoding module 450. Processor 310, which may be embodied by multiple GPUs and/or CPUs may be utilized for processing (e.g., coding and decoding) and/or post-processing. Referring now to FIG. 5, the encoding module 350 and packaging module 360 are shown in conjunction with a representative data flow. For example, the encoding module 350 may be configured to receive, for example, tiled UHD (e.g., 3840×2160) over Quad 3G-SDI in the form of, for example, 8× tiled video content, which may then be processed accordingly, as will be described below in further detail, and transmitted to the CDN.

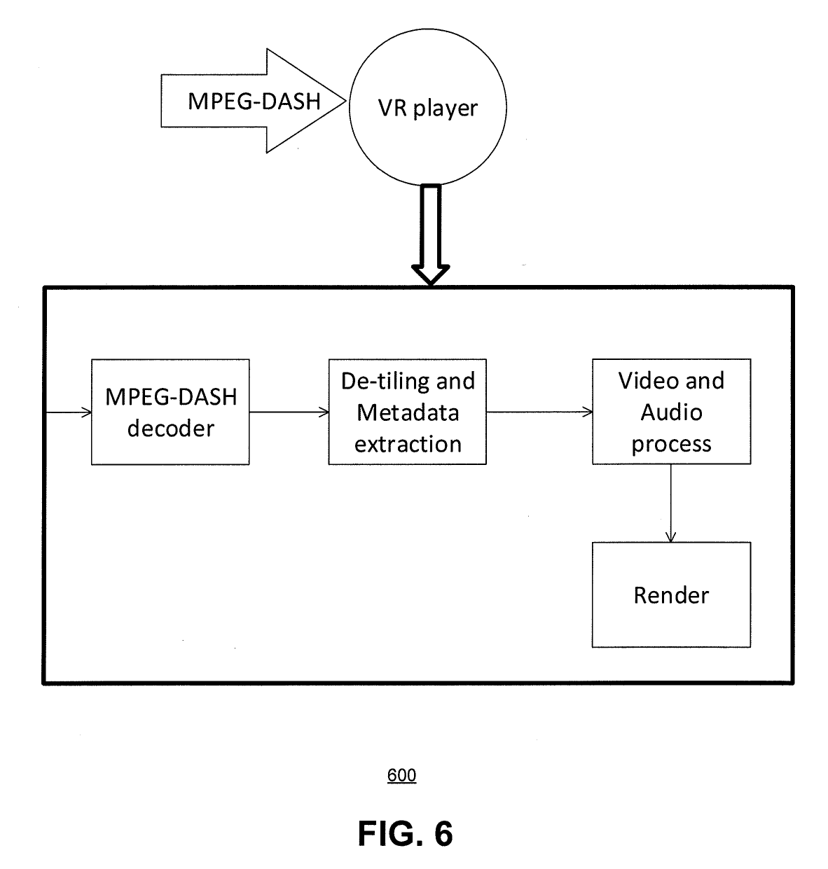

User device 220 also may be embodied by apparatus 300. In some embodiments, user device 220, may be, for example, a VR player. Referring now to FIG. 6, VR player 600 is shown. In some embodiments, VR player 600 may be embodied by apparatus 300, which may further comprise MPEG-DASH decoder 610, De-tiling and metadata extraction module 620, video and audio processing module 630, and rendering module 640.

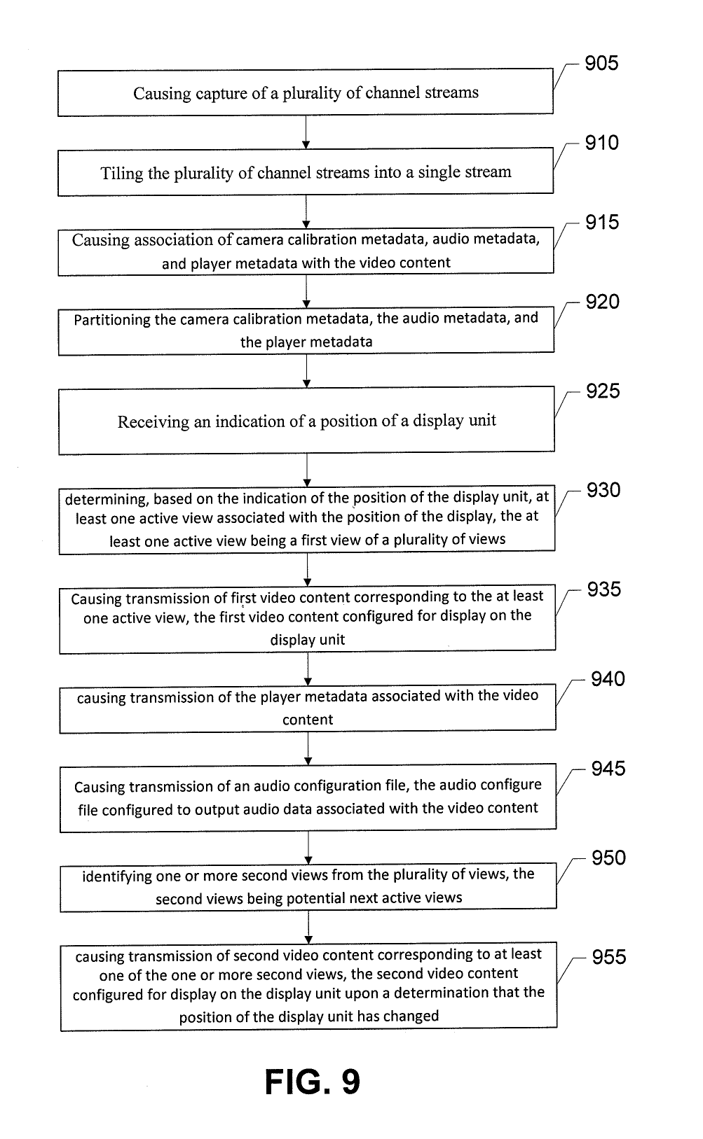

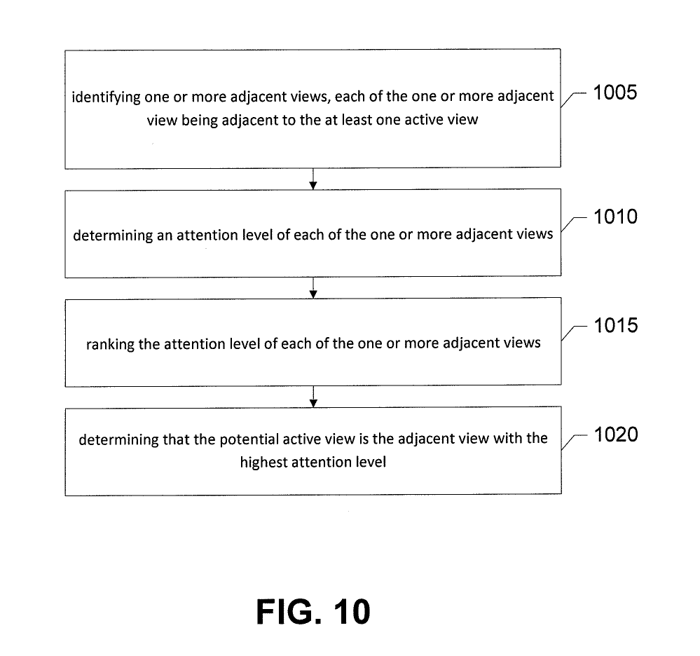

FIGS. 9 and 10 illustrate example flowcharts of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 9 and 10, when executed, convert a computer or processing circuitry into a particular machine configured to perform an example embodiment of the present invention. Accordingly, the operations of FIGS. 9 and 10 define an algorithm for configuring a computer or processing to perform an example embodiment. In some cases, a general purpose computer may be provided with an instance of the processor which performs the algorithms of FIGS. 9 and 10 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included as shown by the blocks having a dashed outline in FIGS. 9 and 10. It should be appreciated that each of the modifications, optional additions or amplifications below may be included with the operations above either alone or in combination with any others among the features described herein.

In some example embodiments, a method, apparatus and computer program product may be configured for facilitating live virtual reality (VR) streaming, and more specifically, for facilitating dynamic metadata transmission, stream tiling, and attention based active view processing, encoding, and rendering.

### Dynamic Metadata Transmission

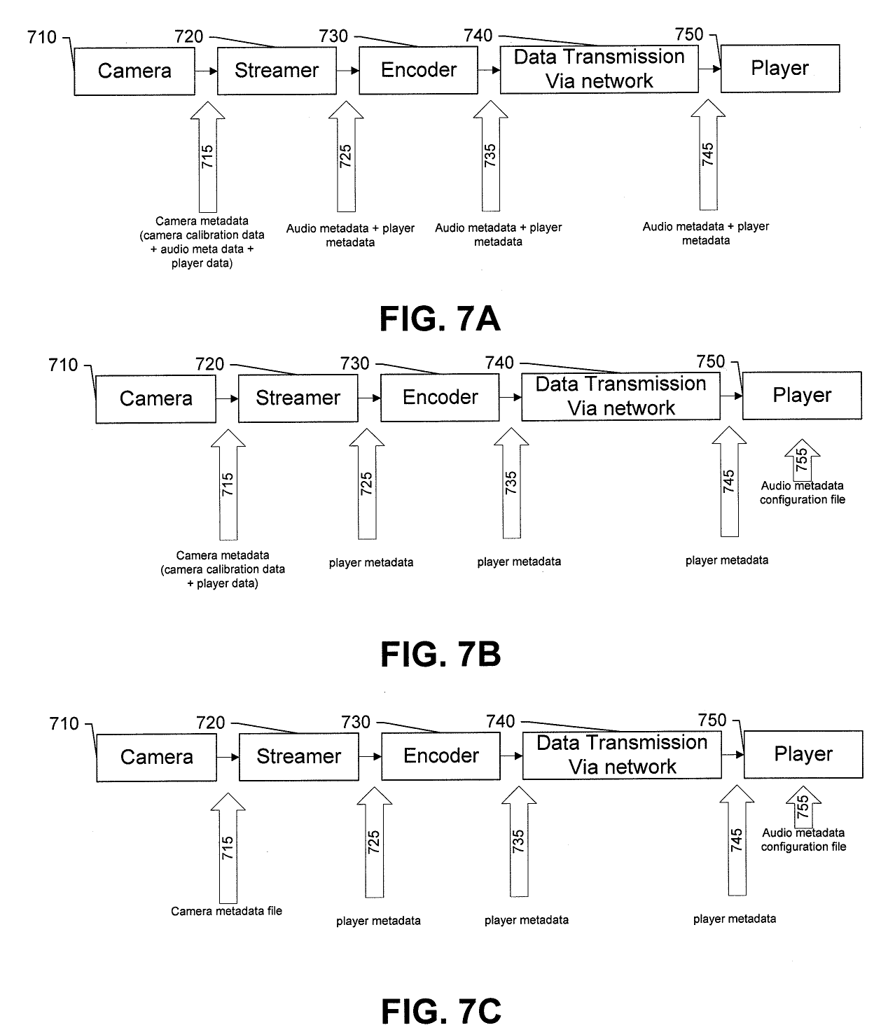

FIGS. 7A, 7B, and 7C show an example data flow diagrams illustrating a process for facilitating dynamic metadata transmission in accordance with an embodiment of the present invention. In particular, in some embodiments, a plurality of types of metadata may be generated at, for example, a camera: (i) camera calibration data including camera properties; and (ii) audio metadata. In some embodiments, player metadata, which may also referred to as tiling metadata, may also be generated. In some embodiments, the two types of metadata data may be transmitted with video data along with SDI, or otherwise uncompressed, unencrypted digital video signals. The streamer may then use the metadata to process the video data. In some embodiments, a portion of the metadata and/or a portion of the types of metadata may be passed along between, for example, the camera, the streamer, the encoder, the network, and the VR player such that the correct rendering process may be applied.

Referring back to FIGS. 7A, 7B, and 7C, the three exemplary embodiments each identify an embodiment in which different types of metadata may be transmitted with the video data captured, at for example, camera 705, to the streamer, the encoder, the network and to the player 725 for, for example, display to the end user.

For example, FIG. 7A shows a self-contained metadata transmission. Content (e.g., video data) is captured by camera 710 and transmitted to streamer 720. In conjunction with the transmission of the video data, metadata 715 may also be transmitted. Metadata 715 may comprise camera metadata, which may comprise camera calibration data, audio metadata, and player data. Streamer 720 may transmit video data to encoder 730 and in conjunction with the transmission of the video data may transmit metadata 725. Metadata 725 may comprise audio metadata and player metadata. Encoder 730 may then transmit the video data to via network to player 750, and in conjunction with the video data, metadata 735 and metadata 745 may be transmitted. Metadata 735 and 745 may comprise audio metadata and player metadata.

FIG. 7B shows an exemplary embodiment that may be utilized in an instance in which an external audio mix is available. That is, in some embodiments, the system may provide audio, not captured from the camera itself. In such a case, the system may be configured to utilize a configuration file in which the audio metadata is described, and feed this configuration file to player. FIG. 7B is substantially similar to FIG. 7A except that none of metadata 715, 725, 735, or 745 comprise audio metadata, and, instead, an audio metadata configuration file may be provided to the player 750.

FIG. 7C shows an exemplary embodiment that may be utilized for calibration and experimentation. For example, for calibration, the system may be configured to inject metadata without using the metadata transmitted from camera. A calibration file can be used for this purpose. FIG. 7C is substantially similar to FIG. 7B except that metadata 715 does not comprise camera calibration data and, instead, calibration metadata may be provided to the streamer 720.

### Stream Tiling

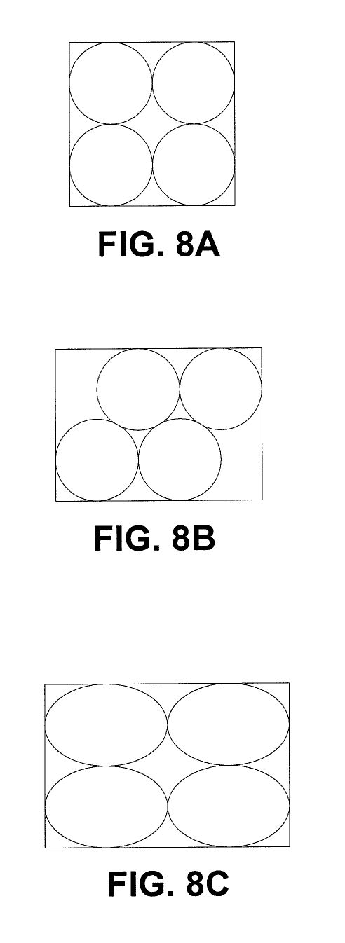

FIGS. 8A, 8B, and 8C show exemplary representations of video frames in the tiling of multiple channel video data into, for example, a single high-resolution stream in accordance with an embodiment of the present invention. In particular, in some embodiments, the system may be configured to transmit the video data, for example, without multiple track synchronization by compositing a multiple-channel stream (e.g., video content from multiple sources such as the lenses of a virtual reality camera) into a single stream. One advantage that tiling may provide is the reduction of necessary bandwidth since each stream may be down-sampled before the tiling. The VR player may then be configured to de-tile the composited stream back to multiple-channel streams for rendering.

The system may be configured to provide one or more of a plurality of tiling configurations. For example, FIG. 8A shows an exemplary embodiment of grid tiling. Specifically, video frames from, for example, each fisheye lens camera may be aligned as shown in FIG. 8A. The advantage here is that the tiling and de-tiling may be performed with minimal complications. One disadvantage is, however, that the rectangular shaped high definition resolution is not fully used. Accordingly, FIG. 8B shows an exemplary embodiments of interleaved tiling. Here, the frame is not aligned, but instead distributed to utilize the space as much as possible. FIG. 8C shows an exemplary embodiment utilizing stretch tiling. Here, the frame is stretched in non-uniform way to further utilize all, or near all, the resolution. While distortion may be introduced in stretch tiling, the system may be configured to provide geometric distortion correction in the performance of de-tiling.

### Attention Based Active View Processing/Encoding/Rendering

FIG. 9 is an example flowchart illustrating a method for attention-based active view processing/encoding/rendering in accordance with an embodiment of the present invention. The full-resolution, full pipeline process, and high bitrate encoding for all views from different cameras is expensive computational processing and a data transmission perspective, and because a user only needs one active view at one time, inefficient. Accordingly, the system may be configured to process one or more active views in high precision and to transmit the data of the one or more active views in high bitrate.

The challenge is to provide a response to the display movement (e.g., user's head position tracking) fast enough such that the user does not perceive delay when the active view changed from a first camera view to a second camera view. The system may be configured to provide a one or more approaches to solving the problem. For example, in one exemplary embodiment, the system may be configured for buffering one or more adjacent views, each adjacent view being adjacent to at least one of the one or more active views. To implement this solution, the system may be configures to make an assumption that the user will not turn his/her head fast and far enough to require providing a view that is not buffered.

In a second exemplary embodiments, the system may be configure to predict head position movement. That is, in the implementation of this embodiment, the system may be configured to make an assumption that the user will not move their head requiring a switch back and forth between active views in short time.

In a third exemplary embodiment, the system may be configured to perform content analysis based data processing, encoding and rendering. That is, content may be identified and analyzed to, for example, rank an attention level for each potential active view. For example, in an instance in which motion, a dramatic contrast of color, or a notable element (e.g., a human face) is detected, the active view comprising the detection may be identified or otherwise considered as having high attention level. Accordingly, the system may be configured to provide more precise post-processing, higher bit-rate encoding and/or more processing power for rendering those potential active views.

In a fourth exemplary embodiment, the system may be configured to perform sound directed processing. That is, because audio may be considered an important cue for human attention, the system may be configured to identify a particular sound and/or detect a direction of the sound to assign and/or rank the attention level of a potential active view.

Referring back to FIG. 9, as shown in block 905 of FIG. 9, an apparatus, such as apparatus 300 embodied by the computing device 210, may be configured to cause capture of a plurality of channel streams. The apparatus embodied by computing device 210 therefore includes means, such as the processor 310, the communication interface 330 or the like, for causing capture of a plurality of channel streams. For example, the computing device may be configured to receive video content, in the form of channel streams, from each of a plurality of cameras and/or lens. For example, a virtual reality camera may comprise a plurality (e.g., 8 or more) precisely places lenses and/or sensors, each configured to capture raw content (e.g., frames of video content) which may be transmitted to and/or received by the streamer (e.g., the streamer shown above in FIG. 4).

As shown in block 910 of FIG. 9, an apparatus, such as apparatus 300 embodied by the computing device 210, may be configured to cause tiling of the plurality of channel streams into a single stream. The apparatus embodied by computing device 210 therefore includes means, such as the processor 310, the communication interface 330 or the like, for causing tiling the plurality of channel streams into a single stream.

As shown in block 915 of FIG. 9, an apparatus, such as apparatus 300 embodied by the computing device 210, may be configured to causing association of one or more of camera calibration metadata, audio metadata, and player metadata with the video content. The apparatus embodied by computing device 210 therefore includes means, such as the processor 310, the communication interface 330 or the like, for causing association of one or more of camera calibration metadata, audio metadata, and player metadata with the video content. As described above, a VR camera may be configured such that metadata is generated upon the capture of video content, the metadata may comprise camera calibration metadata and audio metadata.

As shown in block 920 of FIG. 9, an apparatus, such as apparatus 300 embodied by the computing device 210, may be configured to causing partitioning of the received metadata. Camera calibration metadata, the audio metadata, and the player metadata. The apparatus embodied by computing device 210 therefore includes means, such as the processor 310, the communication interface 330 or the like, for causing partitioning of the metadata. For example, the metadata generated at the VR camera may comprise camera calibration metadata, the audio metadata, and the player metadata, each of which may be separately identified and separated.

Once the video content is captured and desired metadata is associated with the captured video content, the system may be configured to pass along only a portion of the data. As such, as shown in block 925 of FIG. 9, an apparatus, such as apparatus 300 embodied by the computing device 210, may be configured to cause reception of an indication of a position of a display unit. The apparatus embodied by computing device 210 therefore includes means, such as the processor 310, the communication interface 330 or the like, for causing reception of an indication of a position of a display unit. That is, the system may be configured to receive information identifying, for example, which direction an end user is looking, based on the position and, in some embodiments, orientation of a head-mounted display or other display configured to provide a live VR experience.

With the information indicative of the position of the display unit, the system may then determine which portion of the captured data may be transmitted to the user. As shown in block 930 of FIG. 9, an apparatus, such as apparatus 300 embodied by the computing device 210, may be configured to determine, based on the indication of the position of the display unit, at least one active view associated with the position of the display. The apparatus embodied by computing device 210 therefore includes means, such as the processor 310, the communication interface 330 or the like, for determining, based on the indication of the position of the display unit, at least one active view associated with the position of the display. In some embodiments, the at least one active view is just one view (e.g., a first view) of a plurality of views that may be available. That is, the VR camera(s) may be capturing views in all directions, while the user is only looking in one direction. Thus, only the video content associated with the active view needs to be transmitted.

As such, as shown in block 935 of FIG. 9, an apparatus, such as apparatus 300 embodied by the computing device 210, may be configured to causing transmission of first video content corresponding to the at least one active view, the first video content configured for display on the display unit. The apparatus embodied by computing device 210 therefore includes means, such as the processor 310, the communication interface 330 or the like, for causing transmission of first video content corresponding to the at least one active view, the first video content configured for display on the display unit.

In some embodiments, the first video content is transmitted with associated metadata. As shown in block 940 of FIG. 9, an apparatus, such as apparatus 300 embodied by the computing device 210, may be configured to cause transmission of the player metadata associated with the video content. The apparatus embodied by computing device 210 therefore includes means, such as the processor 310, the communication interface 330 or the like, for causing transmission of the player metadata associated with the video content. In some embodiments, the player metadata is any data that may be necessary to display the video content on the display unit. In some embodiments, as described above with respect to FIGS. 7A, 7B, and 7C, the metadata transmitted to the VR player may comprise the player metadata and, only in some embodiments, audio metadata.

In those embodiments in which audio metadata is not associated with the video content during the processing and transmitted to the VR player, an audio configuration file may be provided to the VR player. That is, in some embodiments, external audio (e.g., audio captured from external microphones or the like) may be mixed with the video content and output by the VR player. As shown in block 945 of FIG. 9, an apparatus, such as apparatus 300 embodied by the computing device 210, may be configured to causing transmission of an audio configuration file, the audio configure file configured to output audio data associated with the video content. The apparatus embodied by computing device 210 therefore includes means, such as the processor 310, the communication interface 330 or the like, for causing transmission of an audio configuration file, the audio configure file configured to output audio data associated with the video content.

In some embodiments, the system may be configured to not only determine an active view, but also determine other views that may become active if, for example, the user turns their head (e.g., to follow an object or sound or the like.) and process/transmit video content associated with one or more of those other views also. Accordingly, in such a configuration, those views are identified and a determination is made on what data to process and transmit.

As shown in block 950 of FIG. 9, an apparatus, such as apparatus 300 embodied by the computing device 210, may be configured to cause identification of one or more second views from the plurality of views. The apparatus embodied by computing device 210 therefore includes means, such as the processor 310, the communication interface 330 or the like, for causing identification of one or more second views from the plurality of views. In some embodiments, the second views are potential active views that may be subsequently displayed. The identification of the one or more second views is described in more detail with reference to FIG. 10.

Once the one or second views are identified, the video content associated therewith may be provided to the VR player. As shown in block 955 of FIG. 9, an apparatus, such as apparatus 300 embodied by the computing device 210, may be configured to causing transmission of second video content corresponding to at least one of the one or more second views. The apparatus embodied by computing device 210 therefore includes means, such as the processor 310, the communication interface 330 or the like, for causing transmission of second video content corresponding to at least one of the one or more second views. In some embodiments, the second video content may be configured for display on the display unit upon a determination or the reception of an indication that the position of the display unit has changed such that at least one of the second views is now the active view.

FIG. 10 is an example flowchart illustrating a method for identifying one or more other views in which to perform processing, encoding, and/or rendering in accordance with an embodiment of the present invention. That is, as described earlier, the full-resolution, full pipeline process, and high bitrate encoding for all views both computational and bandwidth prohibitive. Accordingly, in some embodiments, the system may be configured to process a limited number of views in addition to one or more active views in high precision and to transmit the data of the other views in high bitrate.

In some embodiments, each adjacent view to the active view may be buffered (e.g., processed, encoded, and transmitted, but not rendered), whereas in other embodiments, the adjacent views may be identified but other determinations are made to determine which views are buffered. As such, as shown in block 1005 of FIG. 10, an apparatus, such as apparatus 300 embodied by the computing device 210, may be configured to cause identification one or more adjacent views, each of the one or more adjacent view being adjacent to the at least one active view. The apparatus embodied by computing device 210 therefore includes means, such as the processor 310, the communication interface 330 or the like, for causing identification one or more adjacent views, each of the one or more adjacent view being adjacent to the at least one active view. As described earlier, in some embodiments, the system may be configured to buffer each adjacent view.

However, in those embodiments where each adjacent view is not buffered, an attention level may be determined for each adjacent view to aid in the determination of which to buffer. Accordingly, as shown in block 1010 of FIG. 10, an apparatus, such as apparatus 300 embodied by the computing device 210, may be configured to determine an attention level of each of the one or more adjacent views. The apparatus embodied by computing device 210 therefore includes means, such as the processor 310, the communication interface 330 or the like, for determining an attention level of each of the one or more adjacent views. The attention level may be any scoring technique that provides an indication of which views are most likely to be the next active view. In some embodiments, motion, a dramatic contrast of color, and/or a notable element (e.g., a human face) is detected in an adjacent view and contributes the associated adjacent view's attention level. Additionally or alternatively, the source of a sound may be located in one of the adjacent (or in some embodiments, non-adjacent views) and as such contributes to the attention level.

In those embodiments in which a plurality of adjacent views are identified and an attention level is determined, the plurality of adjacent views may be ranked to aid in the determination of which views to buffer. As shown in block 1015 of FIG. 10, an apparatus, such as apparatus 300 embodied by the computing device 210, may be configured to cause ranking the attention level of each of the one or more adjacent views. The apparatus embodied by computing device 210 therefore includes means, such as the processor 310, the communication interface 330 or the like, for causing ranking the attention level of each of the one or more adjacent views.

Once the other potential next views are identified and, in some embodiments, have their attention levels determined, the system may be configured to determine which other view is to be buffered. As shown in block 1020 of FIG. 10, an apparatus, such as apparatus 300 embodied by the computing device 210, may be configured to determine that the potential active view is the adjacent view with the highest attention level. The apparatus embodied by computing device 210 therefore includes means, such as the processor 310, the communication interface 330 or the like, for determining that the potential active view is the adjacent view with the highest attention level. Subsequently, as described with reference to block 955 of FIG. 9, the second video content may be buffered.

It should be appreciated that the operations of exemplary processes shown above may be performed by a smart phone, tablet, gaming system, or computer (e.g., a server, a laptop or desktop computer) optionally configured to provide a VR experience via a head-mounted display or the like. In some embodiments, the operations may be performed via cellular systems or, for example, non-cellular solutions such as a wireless local area network (WLAN). That is, cellular or non-cellular systems may permit VR content reception and rendering.

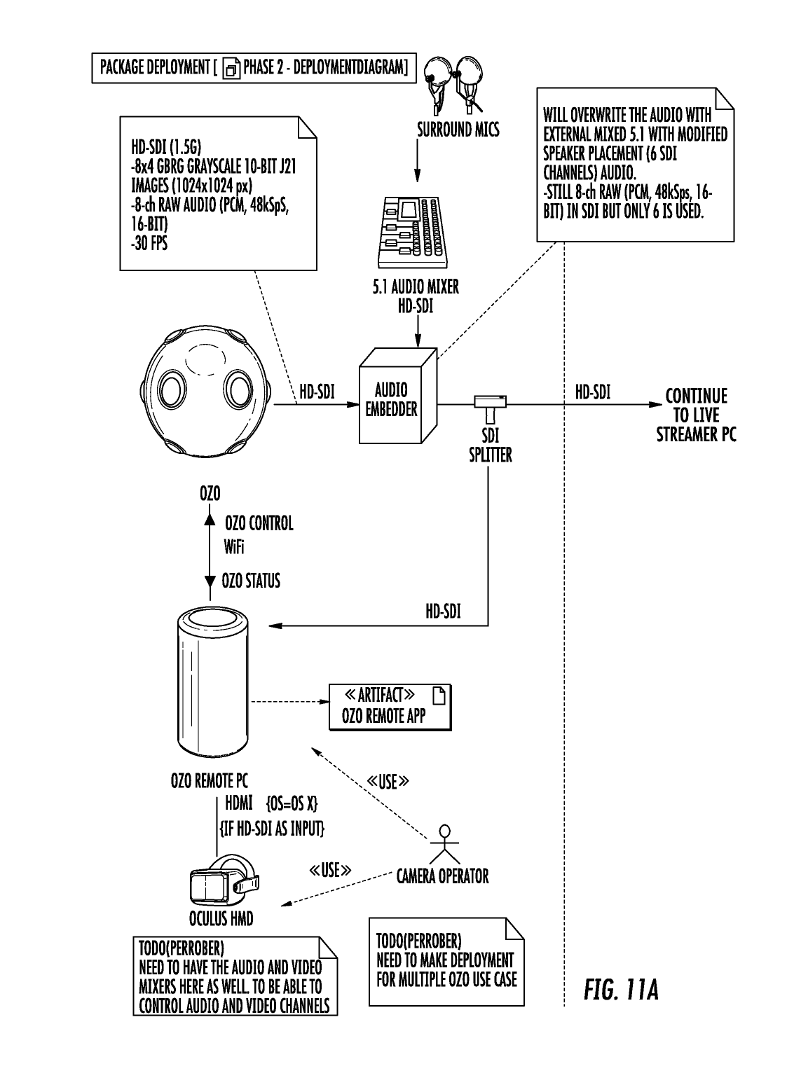

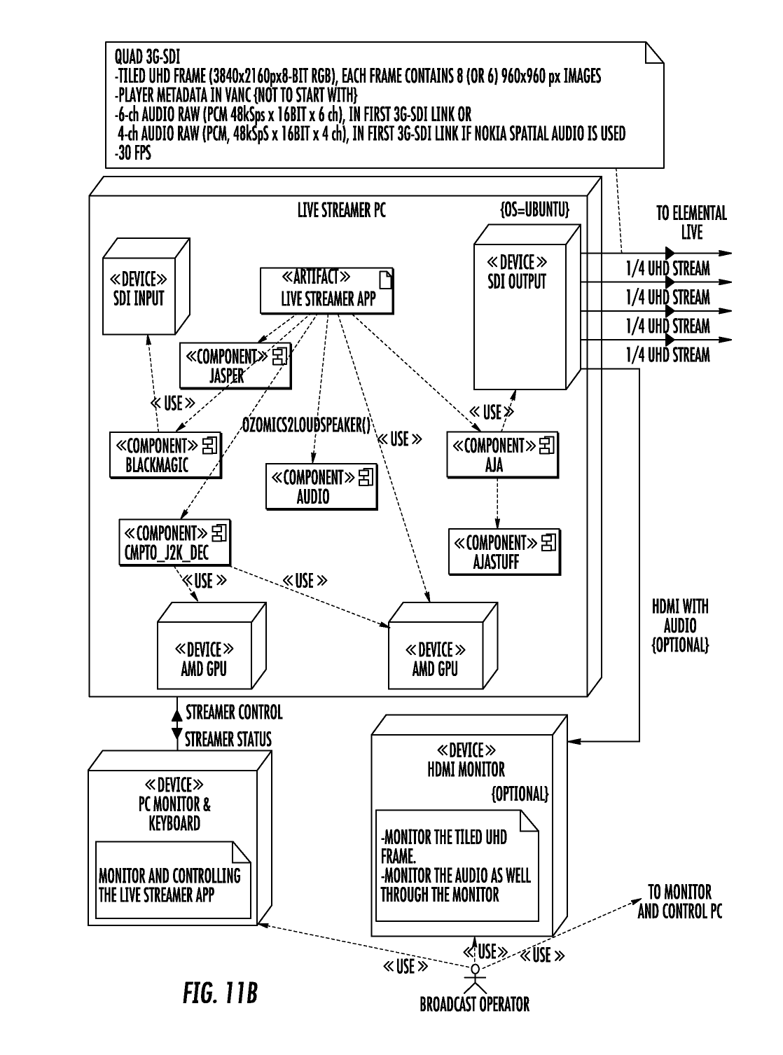

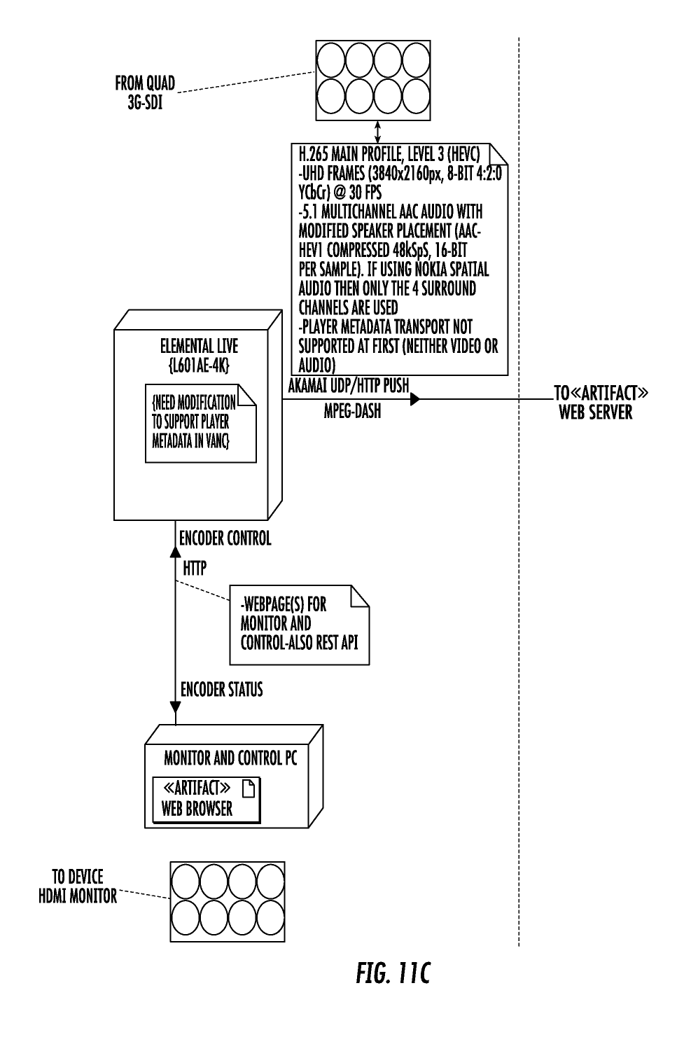

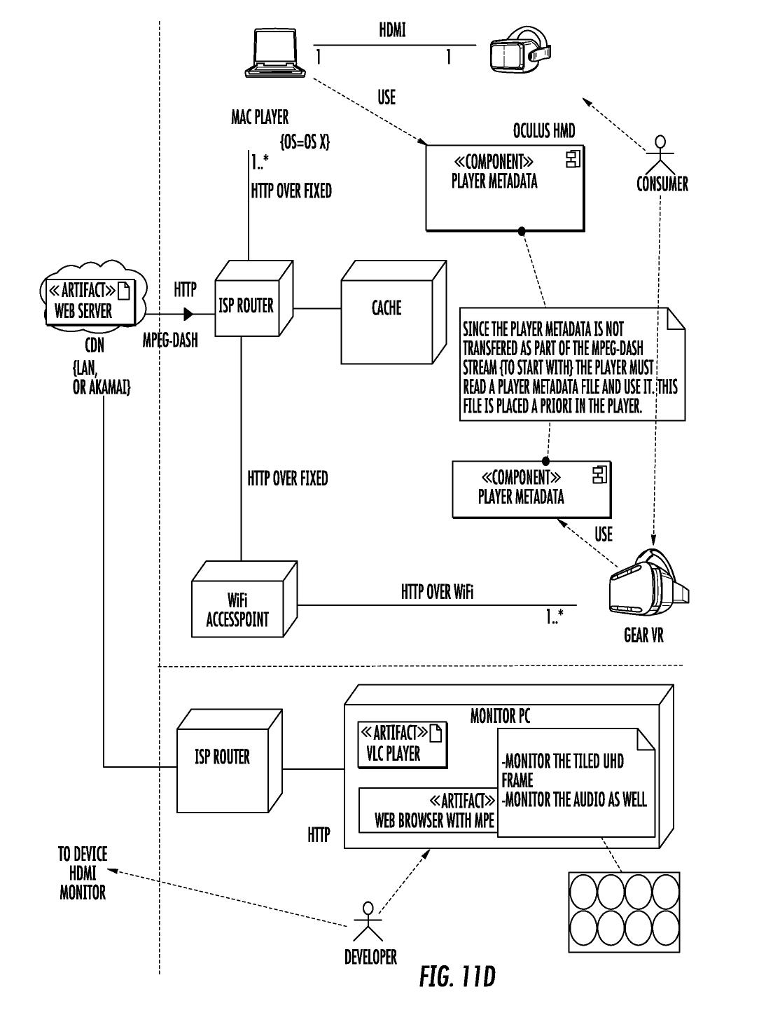

FIG. 11 shows a block diagram of a system that may be specifically configured in accordance with an example embodiment of the present invention. Notably, a VR camera (e.g., OZO). OZO may be configured to capture stereoscopic, and in some embodiments 3D, video through, for example, eight synchronized global shutter sensors and spatial audio through eight integrated microphones. Embodiments herein provide a system enabling real-time 3D viewing, with an innovative playback solution that removes the need to pre-assemble a panoramic image.

LiveStreamerPC may be configured to receive SDI input and output tiled UHD frame (e.g., 3840×2160p×8 bit RGB), each frame comprised of, for example, 6 or 8, 960×960 p×images. LiveStreamerPC may be further configured to output player metadata in VANC and one of 6 or 8 channel audio RAW. A consumer may then be able to view rendered content through the CDN and internet service provider (ISP) router via a HMD unit (e.g., Oculus HMD or GearVR).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to:
cause capture of a plurality of channel streams of video content;
cause capture of calibration metadata, wherein each of the plurality of channel streams of video content having associated calibration metadata;
generate tiling metadata for use in tiling of the plurality of the channel streams, the tiling metadata indicative of a relative position, within a frame, of each of the plurality of channel streams;
tile the plurality of channel streams into a single stream of the video content utilizing the calibration metadata; and
cause transmission of the single stream of the video content.

2. The apparatus according to claim 1, wherein the at least one memory and the computer program code are further configured to, with the processor, cause the apparatus to: partition the calibration metadata and the tiling metadata.

3. The apparatus according to claim 1, wherein the at least one memory and the computer program code are further configured to, with the processor, cause the apparatus to: cause transmission of the tiling metadata within the single stream of the video content.

4. The apparatus according to claim 1, wherein the tiling metadata is embedded in non-picture regions of the frame.

5. The apparatus according to claim 1, wherein the at least one memory and the computer program code are further configured to, with the processor, cause the apparatus to: encode the tiled single stream and the tiling metadata, the encoded data configured for display upon reception of the encoded data at a display unit, extraction of the tiling metadata from the encoded data, and mapping of the tiled single stream of the video content to a plurality of different separate channels in accordance with the tiling metadata.

6. The apparatus according to claim 1, wherein the tiling of the plurality of channels into the single stream comprises at least one of: grid tiling, interleaved tiling, or stretch tiling.

7. The apparatus according to claim 1, wherein the camera metadata further comprises audio metadata, wherein the at least one memory and the computer program code are further configured to, with the processor, cause the apparatus to: partition the audio metadata from the camera metadata; and cause transmission of the audio metadata within the single stream of the video content.

8. The apparatus according to claim 1, wherein the at least one memory and the computer program code are further configured to, with the processor, cause the apparatus to: cause transmission of an audio configuration file, the audio configure file configured to output audio data associated with the video content.

9. The apparatus according to claim 1, wherein the calibration data comprises at least yaw, pitch, and roll information and filed of view information for each of a plurality of cameras configured to capture of the plurality of channel streams of video content.

10. An apparatus comprising at least one processor and at least one memory including computer program code, the at least one memory and the computer program code configured to, with the processor, cause the apparatus to at least:
receive an indication of a position of a display unit;
determine, based on the indication of the position of the display unit, at least one active view associated with the position of the display, the at least one active view being a first view of a plurality of views; and
cause transmission of first video content corresponding to the at least one active view, the first video content configured for display on the display unit.

11. The apparatus according to claim 10, wherein the at least one memory and the computer program code are further configured to, with the processor, cause the apparatus to:
identifying one or more second views from the plurality of views, the second views being potential next active views; and
cause transmission of second video content corresponding to at least one of the one or more second views, the second video content configured for display on the display unit upon a determination that the position of the display unit has changed,
wherein the computer program code for identifying one of the one or more second view are further comprises computer program code configured to, with the processor, cause the apparatus to:
identify one or more adjacent views, each of the one or more adjacent view being adjacent to the at least one active view;
determine an attention level of each of the one or more adjacent views;
rank the attention level of each of the one or more adjacent views; and
determine that the potential active view is the adjacent view with the highest attention level.

12. The apparatus according to claim 10, wherein the at least one memory and the computer program code are further configured to, with the processor, cause the apparatus to:
upon capture of video content, associate at least camera calibration metadata and audio metadata with the video content.

13. The apparatus according to claim 10, wherein the at least one memory and the computer program code are further configured to, with the processor, cause the apparatus to:
cause partitioning the camera calibration metadata, the audio metadata, and the tiling metadata.

14. The apparatus according to claim 13, wherein the at least one memory and the computer program code are further configured to, with the processor, cause the apparatus to:
cause transmission of the tiling metadata associated with the video content.

15. The apparatus according to claim 12, wherein the at least one memory and the computer program code are further configured to, with the processor, cause the apparatus to:
cause transmission of an audio configuration file, the audio configure file configured to output audio data associated with the video content.

16. The apparatus according to claim 10, wherein the at least one memory and the computer program code are further configured to, with the processor, cause the apparatus to:
cause capture of a plurality of channel streams of video content; and
tile the plurality of channel streams into a single stream.

17. The apparatus according to claim 16, wherein the tiling of the plurality of channels into the single stream comprises at least one of: grid tiling, interleaved tiling, or stretch tiling.

18. The apparatus according to claim 10, wherein the display unit is a head mounted display unit.

19. A computer program product comprising at least one non-transitory computer-readable storage medium having computer-executable program code instructions stored therein, the computer-executable program code instructions comprising program code instructions for:
causing capture of a plurality of channel streams of video content;
causing capture of calibration metadata, wherein each of the plurality of channel streams of video content having associated calibration metadata;
generating tiling metadata for use in tiling of the plurality of the channel streams, the tiling metadata indicative of a relative position, within a frame, of each of the plurality of channel streams;
tiling the plurality of channel streams into a single stream of the video content utilizing the calibration metadata; and
causing transmission of the single stream of the video content

20. A computer program product comprising at least one non-transitory computer-readable storage medium having computer-executable program code instructions stored therein, the computer-executable program code instructions comprising program code instructions for:
receiving an indication of a position of a display unit;
determining, based on the indication of the position of the display unit, at least one active view associated with the position of the display, the at least one active view being a first view of a plurality of views; and
causing transmission of first video content corresponding to the at least one active view, the first video content configured for display on the display unit.
